(19) United States
(12) Patent Application Publication
(10) Pub. No.: US 2015/0213235 A1
(43) Pub. Date: Jul. 30, 2015

(54) SYSTEMS AND METHODS FOR PROFILE-INTEGRATED CLINICAL TRIAL FEASIBILITY ASSESSMENTS

(71) Applicant: VIS RESEARCH INC., NEW YORK, NY (US)

(72) Inventors: Fabio Albuquerque Thiers, New York, NY (US); Guilherme Bertini Boettcher, Sao Paulo (BR)

(21) Appl. No.: 14/609,013

(22) Filed: Jan. 29, 2015

Related U.S. Application Data
(60) Provisional application No. 61/932,948, filed on Jan. 29, 2014.

(51) Int. Cl. G06F 19/00

(52) U.S. Cl. CPC G06F 19/363

(57) ABSTRACT

The invention provides tools for generating online feasibility assessments that may be performed live and in which existing profiles of clinical research centers are integrated into the assessment creation process. Tools of the invention allow a planner to create and save new assessment questionnaires, and then to craft the questions in those assessment tools while also provisionally filtering centers, pre-populating assessment data based on center profiles, or both.

### CROSS-REFERENCE TO RELATED APPLICATION

This application claims the benefit under 35 U.S.C. §119(e) of U.S. provisional application Ser. No. 61/932,948, filed Jan. 29, 2014, the contents of which is incorporated by reference herein in its entirety.

### FIELD OF THE INVENTION

The invention generally relates to systems and methods for creating feasibility assessments for use in planning clinical trials.

### BACKGROUND

A person suffering from a disease can typically only take a life-saving drug once it has been approved by the government. Government approval requires a series of clinical trials on a large number of patients. Planning clinical trials is a complex process that takes time and money as a trial planner mails feasibility questionnaires to clinical research centers in hopes that enough centers will send back answers. If the planner identifies enough centers with adequate capacity and willingness to conduct a trial, the potentially life-saving drug can enter clinical trials.

Trial planners have particular difficulty planning multi-site trials. Even if each research center sends back a completed feasibility questionnaire, the trial planner must identify what combination of centers provides the desired capacity. Planning a clinical trial is an expensive and ad hoc project in which a trial planner goes through survey results trying to put together a suitable group of research centers. Information about the centers, and factors such as available patient population and local regulatory rules, if available at all, is scattered across complex and incomplete papers or spreadsheets, the nature of which does little to aid decision-making.

Some companies purport to aid in running clinical trials. For example, ePharmaSolutions (Conshohocken, Pa.) purports to offer tools for site management and patient enrollment. CenterWatch (Boston, Mass.) is a provider of clinical trials information for pharmaceutical companies. Clinuity, LLC (Aspen, Colo.) offers a community for clinical research professionals. TrialNetworks (Needham, Mass.) provides tools for managing clinical trials. Patent documents such as U.S. Pat. No. 8,533,008; U.S. Pat. No. 8,529,446; and U.S. Pat. No. 8,620,680 mention trials, but these are not concerned with feasibility assessments and do not help in identifying candidate sites. If a trial planner wants to identify locations that could potentially participate in a trial (i.e., not yet enroll patients), that planner must still send a feasibility questionnaire in hopes that the sites will complete and return it.

### SUMMARY

The invention provides tools for generating feasibility assessments in which existing profiles of clinical research centers are integrated into the assessment creation process. Tools of the invention allow a planner to create and save new assessment questionnaires, and then to craft the questions in those assessment tools while also provisionally filtering centers, pre-populating assessment data based on center profiles, or both. Systems of the invention give the planner an interface from which to compose the assessments, push them to the research centers, aggregate incoming results, and view centers. Viewing results and centers can include viewing feasibility assessment results in a comparative matrix view, viewing fine-level details about various individual centers including data on available patient population, personnel, infrastructure, environment, or others, and viewing scores ranking the centers (e.g., based on weighted criteria provided by the planner). The interface can provide the ability for a planner to adjust his or her input weights and watch the centers' scores re-adjust dynamically, in real-time. For example, a planner may decide to down-weight average patient enrollment time and up-weight the center's jurisdiction having a regulatory fast-track; that planner can see his or her top ten list change automatically as he or she slides the appropriate weight sliders into their new positions.

The invention provides tools for generating, cloning, pushing questions along with integration with profiles and pre-existing lists. The integrated profiles are open in the sense that they can contain information sourced from publically-available data and also information that is contributed directly from the research centers, as well as from private data directly inputted. Systems of the invention allow for a “head-to-head” comparison of clinical research centers that are suitable potential candidates for participating in a clinical trial.

Aspects of the invention provide a system for preforming a feasibility assessment for a clinical trial. The system includes a server computer comprising a processor coupled to a memory. The system is operable to store information about a research center in a profile, provide an interface that a trial planner can use to create an assessment comprising a plurality of questions, pre-populate an answer for at least one of the questions using the information about the research center stored in the profile, and provide the assessment to a representative of the research center. The representative of the research center may see the pre-populated answer.

In some embodiments, the system is operable to save a plurality of assessments and transmit the saved assessment to research centers upon instruction by a trial planner.

In certain embodiments, the system is operable to receive a completed assessment from a research center. Preferably, the system is operable to present the completed assessment to the trial planner. The system may be operable to update the profile to include new information obtained from the representative answering the assessment. In some embodiments, the system is operable to receive, from the trial planner, expected answers for the plurality of questions. The system can allow the trial planner to assign a weight to each of the expected answers.

In certain embodiments, the system will receive answer values for the plurality of questions from the research center, calculate a score for the research centers based on the weights for the expected values and the received answer values, and provide the trial planner with the score for the research center. Preferably, the system can show the trial planner a comparison between the research center and a second research center based on answers that include information from the profile and information provided by research center personnel.

Aspects of the invention provide a method for preforming a feasibility assessment for a clinical trial. The method includes using a server computer comprising a processor coupled to a memory to store information about a research center in a profile, provide an interface that a trial planner can use to create an assessment comprising a plurality of questions, pre-populate an answer for at least one of the questions using the information about the research center stored in the profile, and provide the assessment to a representative of the research center.

In some embodiments, the method includes saving a plurality of assessments and transmitting the saved assessment to research centers upon instruction by a trial planner. The representative of the research center may see the pre-populated answer. A completed assessment may be received back from a research center. The completed assessment is presented to the trial planner. In some embodiments, the method includes updating the profile to include new information obtained from the representative answering the assessment.

Expected answers for the plurality of questions may be received from the trial planner. The trial planner may assign a weight to each of the expected answers. Answer values for the plurality of questions from the research center can be received, and the method includes calculating a score for the research centers based on the weights for the expected values and the received answer values and providing the trial planner with the score for the research center.

In certain embodiments, the method includes showing the trial planner a comparison between the research center and a second research center based on answers that include information from the profile and information provided by research center personnel.

### BRIEF DESCRIPTION OF THE DRAWINGS

FIG. 1 shows a system of the invention.

FIG. 2 shows a home screen.

FIG. 3 shows a screen for creating questions.

FIG. 4 shows a screen for selecting a disease type.

FIG. 5 shows a trial planner, having selected arrhythmia, is creating an assessment.

FIG. 6 shows a screen at which a trial planner constructs a question.

FIG. 7 shows a trial planner using the system.

FIG. 8 illustrates setting a question's answer type to “number.”

FIG. 9 illustrates composing a portion of a feasibility questionnaire.

FIG. 10 gives a screen from which a trial planner can invite centers.

FIG. 11 shows a screen that a person at a research center would access.

FIG. 12 shows a screen that may be displayed to research center personnel.

FIG. 13 illustrates trial-specific questions.

FIG. 14 shows a screen from which a completed assessment may be submitted.

FIG. 15 shows that research center personnel have completed an assessment.

FIG. 16 gives a display from the point of view of the trial planner.

FIG. 17 shows an “infrastructure page”.

FIG. 18 shows a disease-specific infrastructure screen.

FIG. 19 shows presenting information about patients that are available for trials.

FIG. 20 illustrates a display for comparing centers.

FIG. 21 diagrams methods according to certain embodiments.

FIG. 22 shows a schematic of system of the invention.

FIG. 23 shows a dynamic scoring screen.

### DETAILED DESCRIPTION

The invention provides tools for generating feasibility assessments in which existing profiles of clinical research centers are integrated into the assessment creation process. Problems and issues in feasibility questionnaires, and the notable shortcomings of prior art methods, are discussed for example in Burgess & Sulzer, 2011, Examining the clinical trial feasibility process and its implications for a trial site, Open Access Journal of Clinical Trials 3:51-54; Rajadhyaksha, 2010, Conducting feasibilities in clinical trials: an investment to ensure a good study, Perspect Clin Res 1(3):106-109; McAlindon, 2003, Conducting clinical trials over the internet: feasibility study, BMJ 327:484-487; and Cummings, 2007, Chapter 15: Designing questionnaires, interviews, and online surveys, in Gaertner, et al., Eds., Designing Clinical Research, Lippincott Williams & Wilkins, Philadelphia, Pa., the contents of each of which are incorporated by reference. At the core of the clinical trial feasibility process is the assessment, by which a trial planner seeks to evaluate various research centers for their potential fitness to participate in a prospective clinical trial.

The invention provides systems and methods for integrating online profiles of research centers into the assessment process. Systems of the invention provide research center, personnel, and geographic profiles. A profile is an aggregation of information organized to give information about clinical research capacity for the profiled entity and viewable or obtainable as a web page or document. Profiles are fed by an underlying database as described, for example, in related application U.S. Pub. 2013/0151276 (incorporated by reference), which describes providing a profile of a research center. The underlying database represents a collection of information, pieces of which provide information about the capacity of a research center to participate in a trial. Preferably, since a prospective clinical trial may relate to a disease, profiles and assessments as described herein can always be employed in a disease-specific fashion. Thus, a trial planner may create a disease-specific clinical trial feasibility assessment and creation of the assessment can incorporate information already in the system that is pertinent to the disease-specific capabilities of one or more research centers. One of skill in the art will recognize categories of information that may be pertinent to disease-specific clinical trials. Information that may be used is discussed in U.S. Pub. 2013/0151280; U.S. Pub. 2013/0151279; U.S. Pub. 2013/0151278; U.S. Pub. 2013/0151277; U.S. Pub. 2013/0151276; and U.S. Pub. 2013/0151275, the contents of each of which is incorporated by reference in their entirety.

Using systems and methods of the invention, a trial planner can create a feasibility assessment and push it to prospective centers.

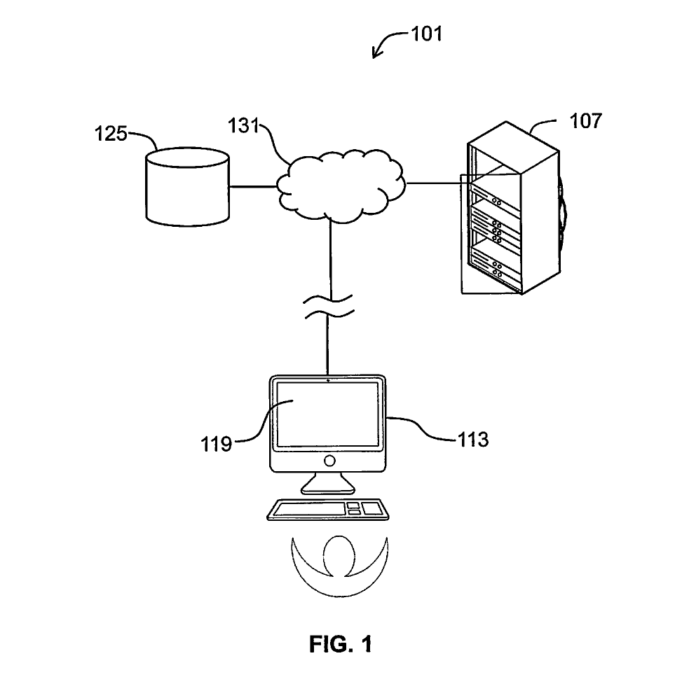

FIG. 1 shows a system 101 for creating an assessment. System 101 may include, as-needed, server 107, planner computer 113, and resource 125 all able to communicate with one another via communication network 131. Computer 113 presents display 119 to the trial planner, and it is from this interface that the planner creates the assessment. Assessment tools as provided by the invention allow a trial planner to zero and interact with research sites, via a set of questions that matter to a relevant, specific protocol. This brings in relevant and critical information that would otherwise take very long to get to.

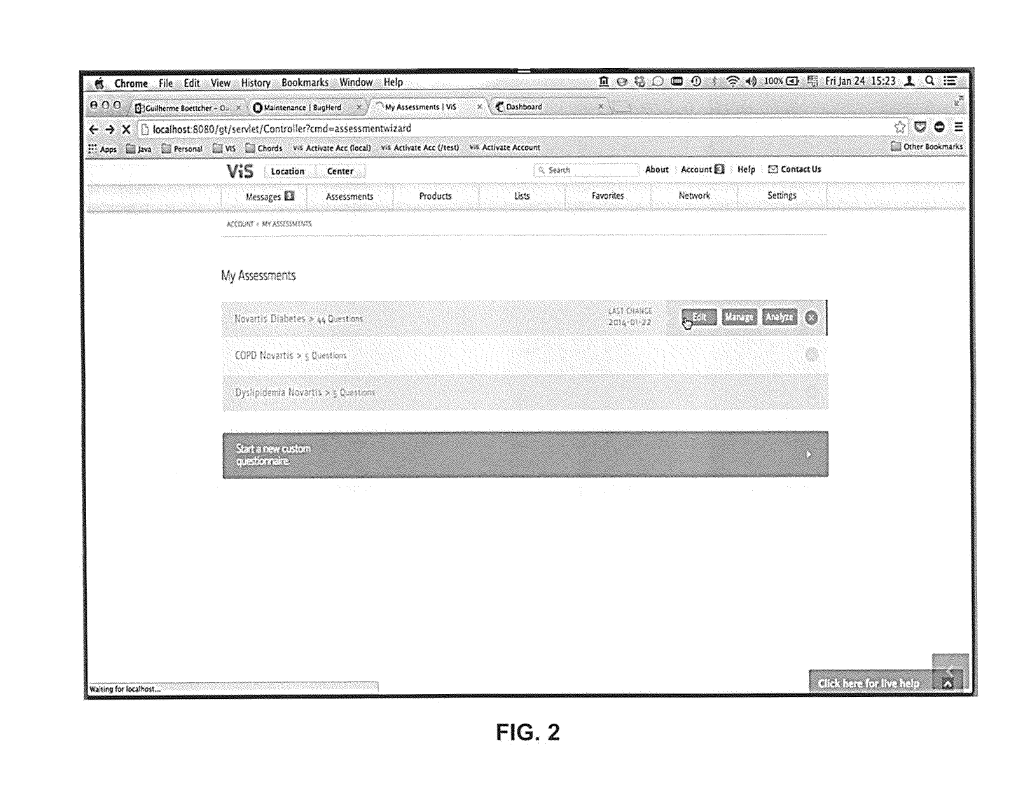

FIG. 2 shows a home screen from which a trial planner may create, work on, save, or send a feasibility assessment. In the illustrated home screen, a trial planner has already created three assessments and sees a list of those. If the trial planner hovers the mouse pointer over one of the assessments, options appear that may include edit, manage, and analyze. From this screen, the trial planner can work on building an existing assessment or can create a new assessment to build.

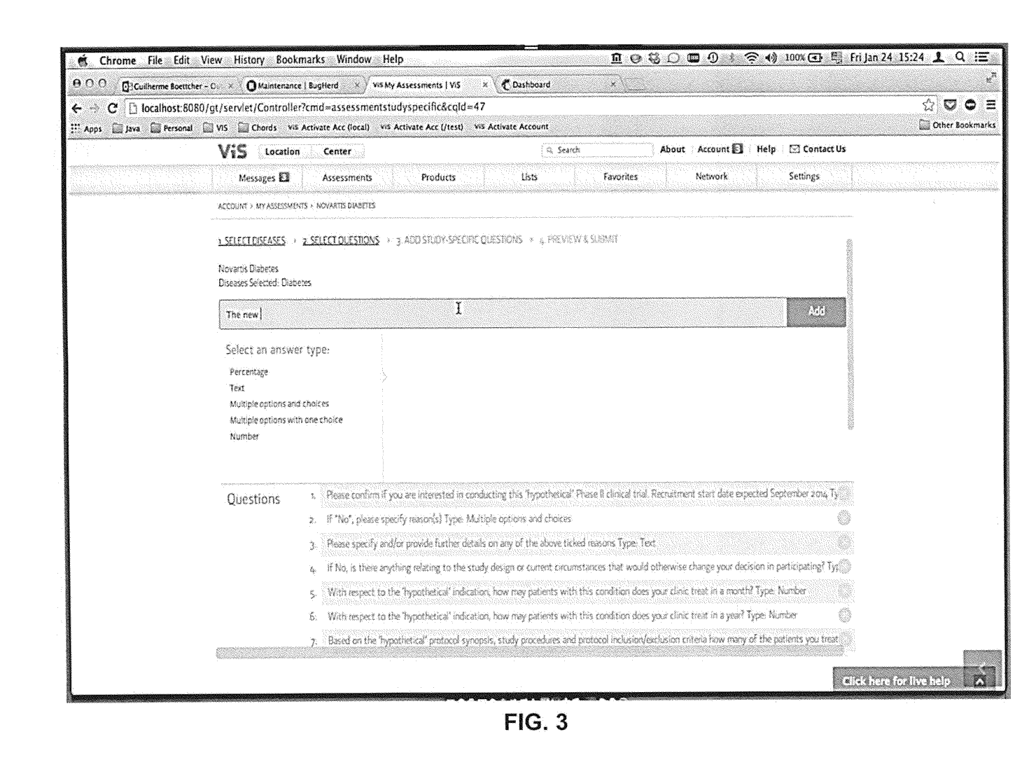

FIG. 3 shows a screen for creating questions within a feasibility assessment. It can be seen that a trial planner has options to select diseases, select questions, add study-specific questions to the assessment, and to input question text directly. The assessment tool can offer existing questions that a trial planner can include in the assessment. For example, “Please confirm that you are interested in participating in this hypothetical phase II clinical trial”. These questions can be fully pre-scripted or can be written by a computer program of the invention using partial scripts and plug-in rules. An important feature of the invention is the ability to operate all assessments with a disease-specific informational constraint. That is, the trial planner can select a disease and systems of the invention will limit the tool offerings to specific tools or questions that offer a connection that selected disease.

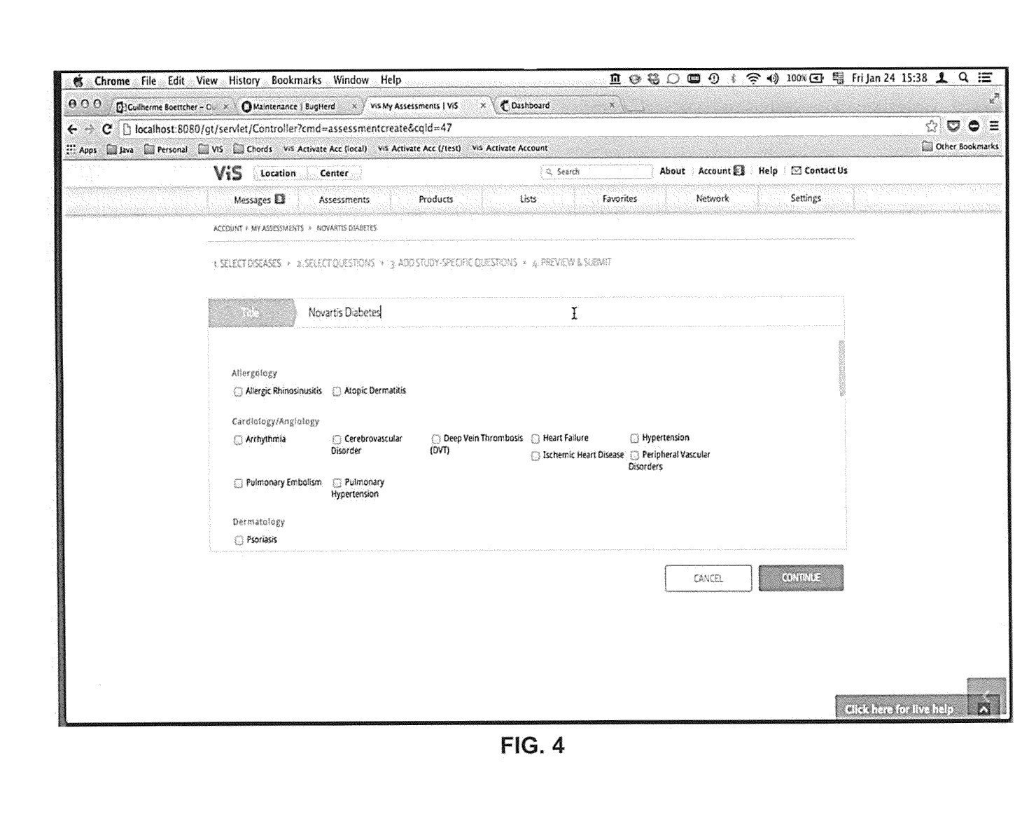

FIG. 4 shows a screen for selecting a disease type. As shown in FIG. 4, selecting a disease can be done through an interface that is organized into categories (e.g., Allergology, Cardiology, . . . ) with tick boxes by entries in those categories. Other formats of presenting the diseases may be used including, for example, a simple list, text input from the trial planner, look-up to an extrinsic database, or others.

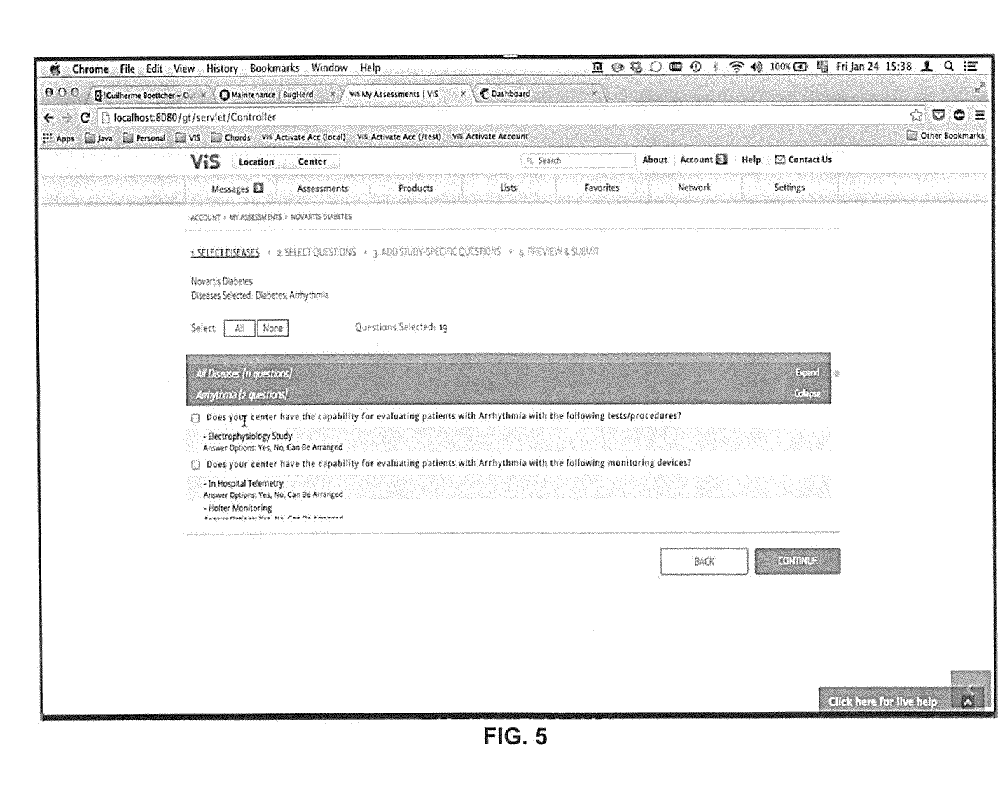

FIG. 5 shows a trial planner, having selected arrhythmia, is creating an assessment and is presented with questions that are associated with arrhythmia. This can aid a trial planner in tailoring the assessment to the protocols of the proposed trial. For example, having selected arrhythmia, the canned questions can include a query as to whether a responding research center has telemetry hardware and can even include a sub-question about the facility's ability to do Holter monitoring.

As a trial planner selects questions, for one of or all of the questions, the planner can structure the potential answers.

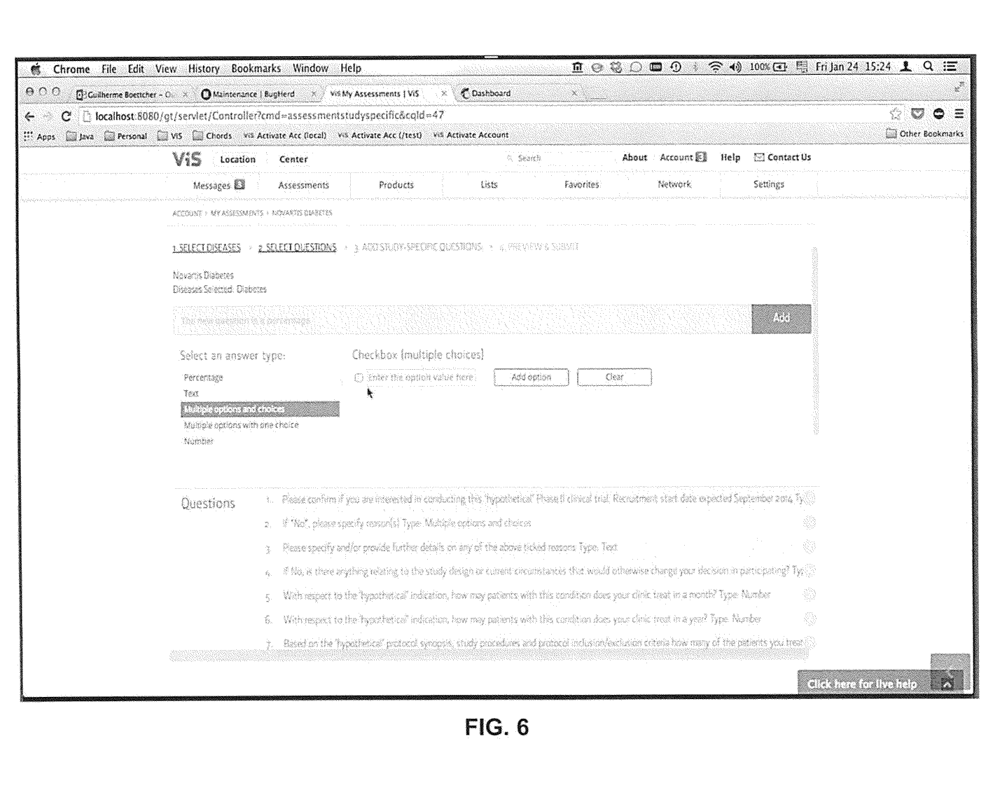

FIG. 6 shows a screen at which a trial planner constructs a question, selecting question type and answer possibilities. Here, in the depicted scenario, the trial planner has specified that a question will have a multiple choice answer. The display 119 gives the trial planner a field for entering option values that will appear alongside the multiple choice checkboxes. From this display 119, the trial planner could optionally choose other answer formats instead of multiple choice such as, for example, text entry, or selection of a percentage, or a numeral.

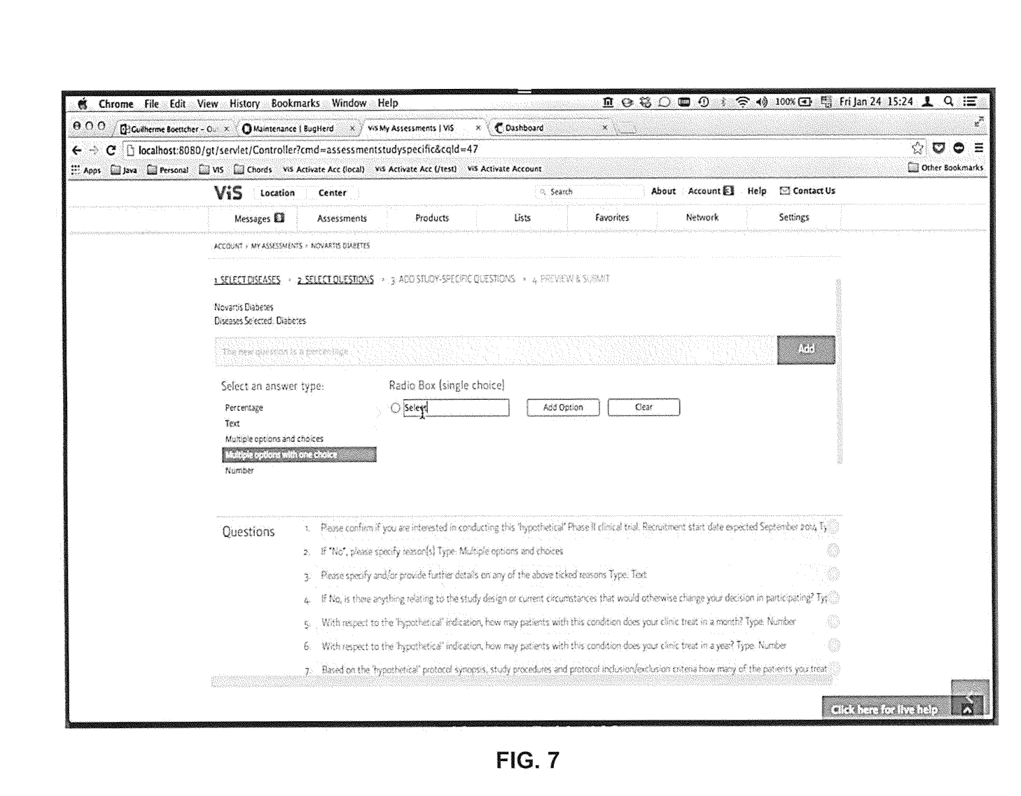

FIG. 7 shows a trial planner using the system to create an answer structure for a multiple choice question. Here, the trial planner has chosen “Multiple options with one choice” and is setting up the multiple options that will be presented with a radio box.

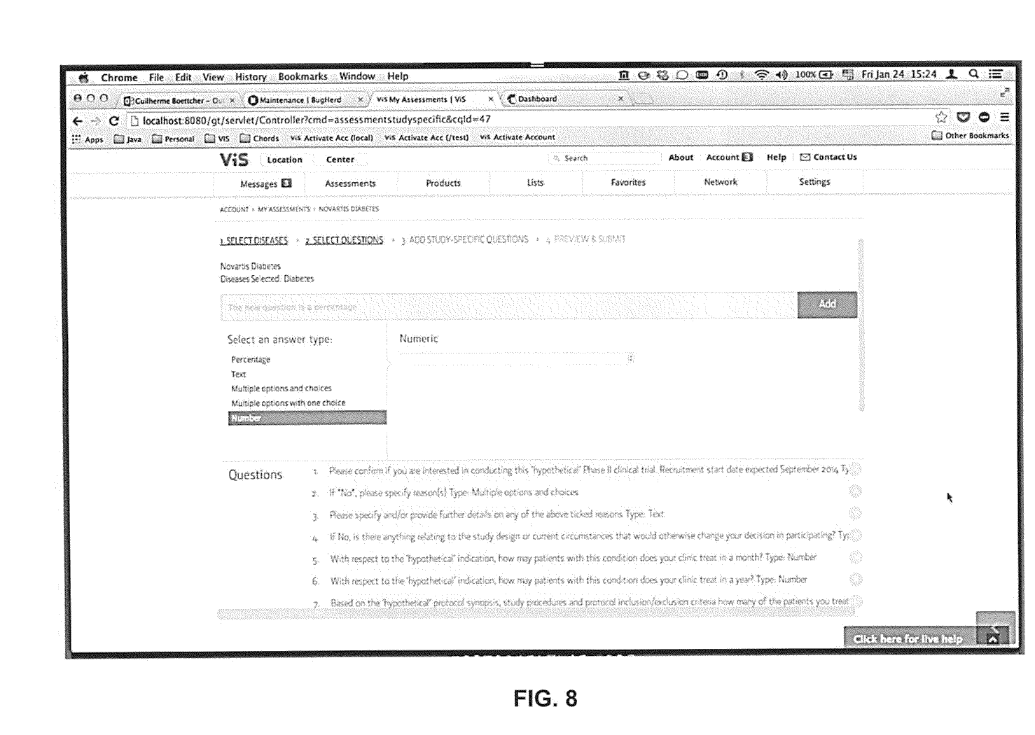

FIG. 8 illustrates setting a question's answer type to “number.” Besides mechanisms for creating questions with specific structures, systems of the invention also provide tools to control the overall structure of an assessment. For example, the assessment creation tool can present opportunities for the trial planner to add both general questions and, separately, trial-specific questions. General questions could be directed to the availability of a research center to participate in a clinical trial generally. Or, for example, a general question may inquire about the regulatory environment of the jurisdiction that the research center occupies. Other general questions may target infrastructure (e.g., on-site parking or access to public transportation) or scientific infrastructure (e.g., MRI, x-ray machine). Trial specific questions—which can overlap with general questions—can ask information that is specific the clinical trial that the planner is planning. One valuable feature of the invention is the ability to integrate existing information into the assessment process. One example of existing information is the text of questions.

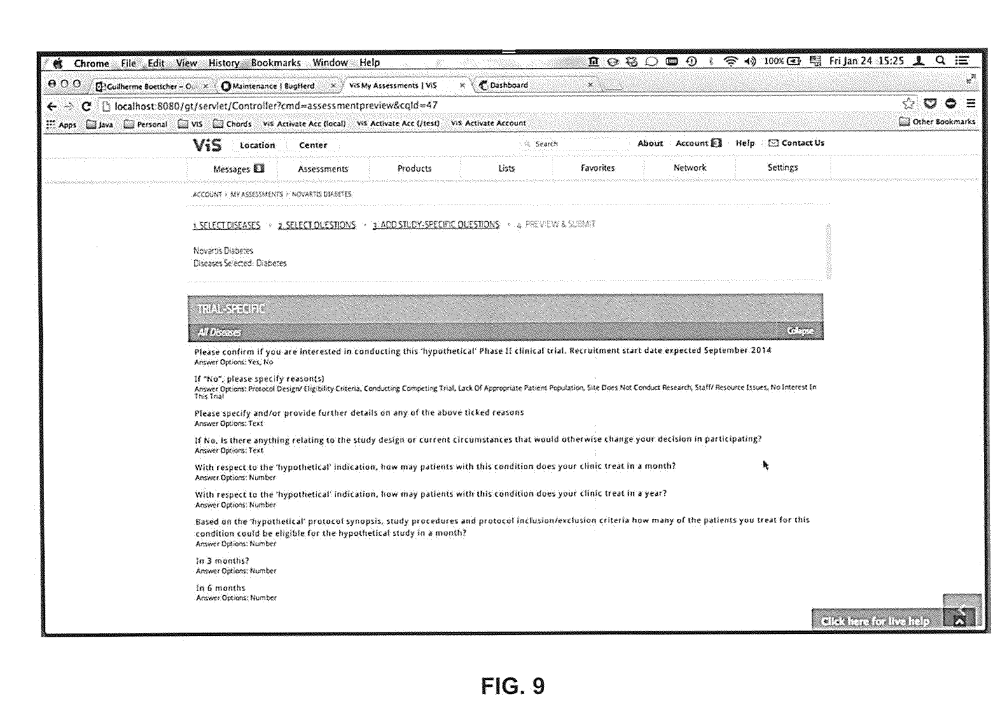

FIG. 9 illustrates composing a portion of a feasibility questionnaire that is trial-specific. In the display 119 depicted in FIG. 9, a planner is presented with pre-existing questions that may be pertinent to the nascent trial as determined by the system for example as based on links between keywords in the questions and in the planners set-up of the assessment. For example, having ticked that the assessment was a Phase II clinical trial, systems of the invention may present a set of questions about participation in Phase II clinical trials.

Once a trial planner has completed an assessment, he or she can go back and edit that assessment. The assessment can even be edited after a research center has answered it. Systems and methods of the invention can be operated to update the information based on existing database profiles and to prompt the research center for more information as-needed if the assessment is changed after being completed. In general, a trial planner will complete an assessment and will also select research centers to be assessed, and will invite those centers to complete the assessment.

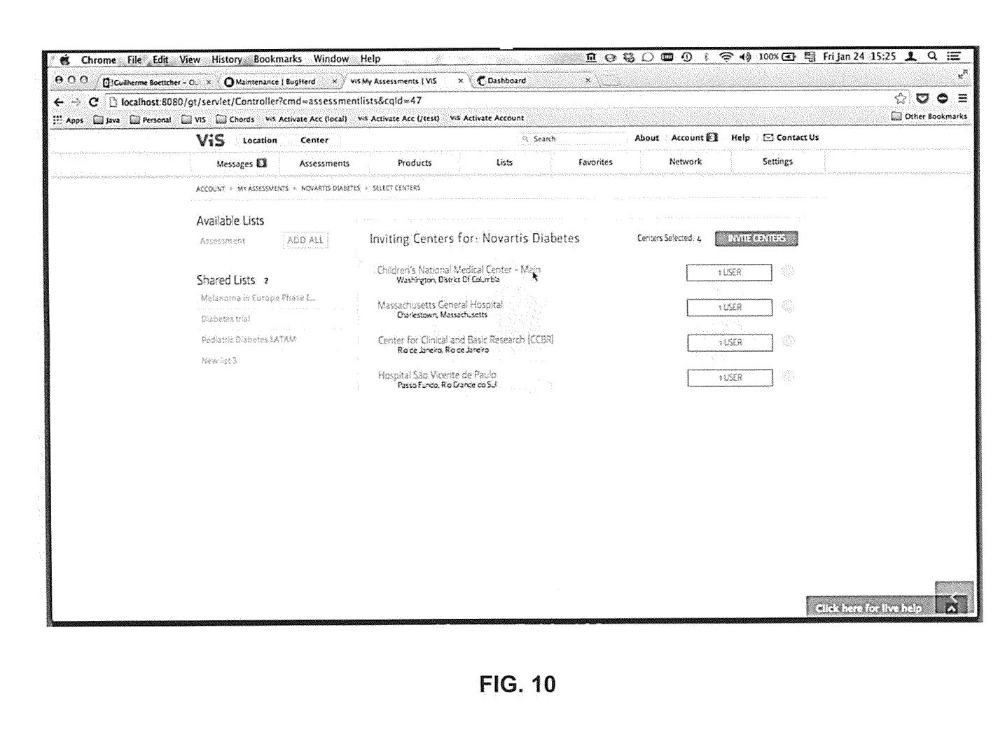

FIG. 10 gives a screen from which a trial planner can invite centers to complete the feasibility questionnaire. It is worth noting that some portions of an assessment may be filled automatically by systems and methods of the invention. In general, systems of the invention will compare questions in the assessment to information in a research center's profile within the system.

When information In that is in the system within a profile P of research center C supplies the answer An to one of the questions Qn in an assessment A (e.g., having n questions), and when that research center is selected to participate in the assessment, the system can pre-populate the answer An to question Qn with information In to decrease the workload on personnel at center C and to aid the trial planner in getting accurate information. Noting that FIG. 10 shows a screen for inviting centers to complete an assessment, the pre-population step can happen before or after the center C is invited to participate in the assessment A. It may be helpful to a trial planner to have information pre-populated as the trial planner creates an assessment or just prior to inviting the centers. This can help pre-screen centers so that the trial planner can target those centers that will meet the protocol criteria. It may also be helpful to see the prepopulated answers while composing the questions as the answer to one question may inform the need to include some additional question (e.g., no MRI on-site may indicate the need to ask if there is an MRI within the same city).

From the display 119 shown in FIG. 10, a trial planner can click to invite centers and can see a list of proposed centers, such as a list of centers for which that trial planner has contacts. Once the trial planner has established the list of centers to be invited, the assessment can be sent to those centers by clicking “Invite centers”.

Methods of the invention take advantage of recent trends by which large CROs are pushing out many invitations to be part of private networks. Here, the CROs may participate in a public network characterized by open profiles wherein any user (optionally subscribers) can view profiles and conduct research to identify sets of centers according to various criteria. As more CROs or research centers participate in the system, the more information they will provide to be pre-loaded into systems of the invention. The more information that is pre-loaded, the more questions within assessments can be pre-answered.

Using systems and methods of the invention, a trial planner can perform a feasibility assessment for a prospective clinical trial wherein the process of creating and administering the feasibility assessment, and the feasibility assessment that is created, are integrated with existing profiles of research centers, personnel, and geographic locations. A feasibility assessment includes a set of questions to be presented to one or more research centers. Systems of the invention integrate the assessment with profiles by pulling information from a profile to provide information in response to the assessment (e.g., pre-populating at least one answer in an assessment based on information within a profile within the system). Thus the invention provides systems and methods for profile-integrated clinical trial feasibility assessments. Not only can the invention support the initial creation of the assessments, in some embodiments, systems and methods of the invention are used to aid a representative from a research center in completing (“responding to”) a feasibility assessment, and also to collect responses and score centers.

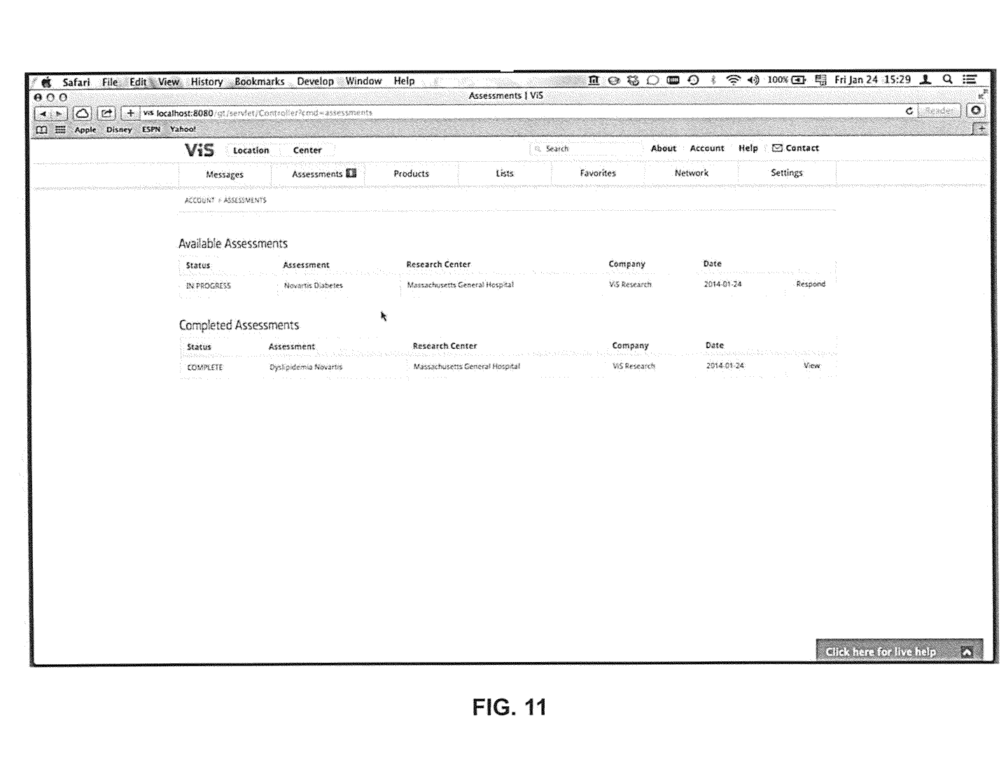

FIG. 11 shows a screen that a person at a research center would access to respond to assessments. FIGS. 11-14 each show a display 119 from the point-of-view of a person at a research center responding to an assessment using their own computer 113. From the display 119 shown in FIG. 11, a center representative can choose to respond to an assessment.

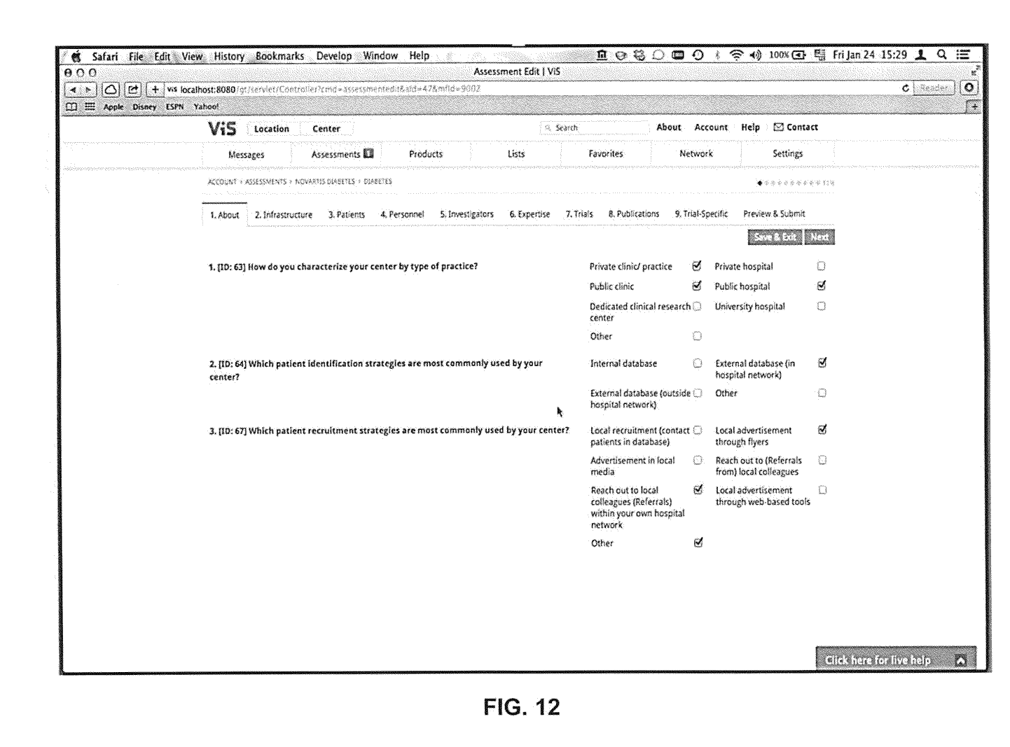

FIG. 12 shows a screen that may be displayed to a research center personnel as that person progresses through an assessment. From this page, the center representative responds to an assessment. Answering here also updates the center's profile. This provides an additional way in which the assessment is integrated with the profile component of the system. Looking at any of the questions shown in FIG. 12 (i.e., 1. How do you characterize your center by type of practice?; 2. Which patient identification strategies are most commonly used by your center?; and 3. Which patient recruitment strategies are most commonly used by your center?), any information provided here by a center representative may be used to update that center's profile.

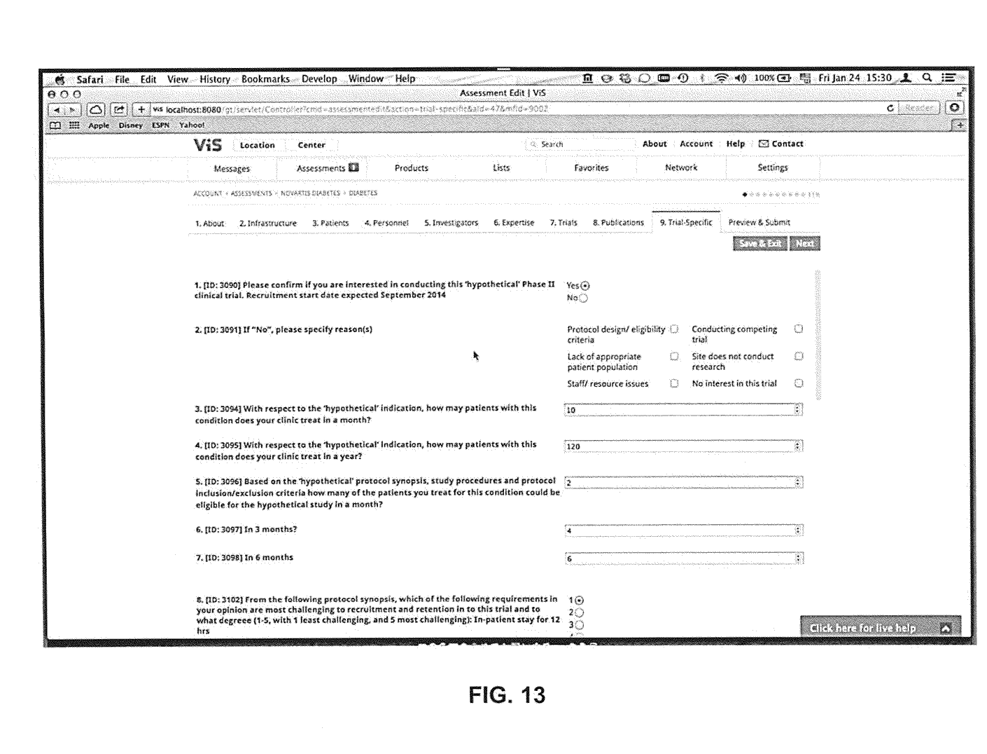

FIG. 13 illustrates trial-specific questions that may appear to center personnel as part of an assessment. These trial-specific questions can have their answer values pre-loaded based on information within the system profiles. Thus the representative of the research center can review the questions and those answers that are pre-loaded from the profile and submit the completed assessment including those pre-loaded answers using information from the pre-existing profiles.

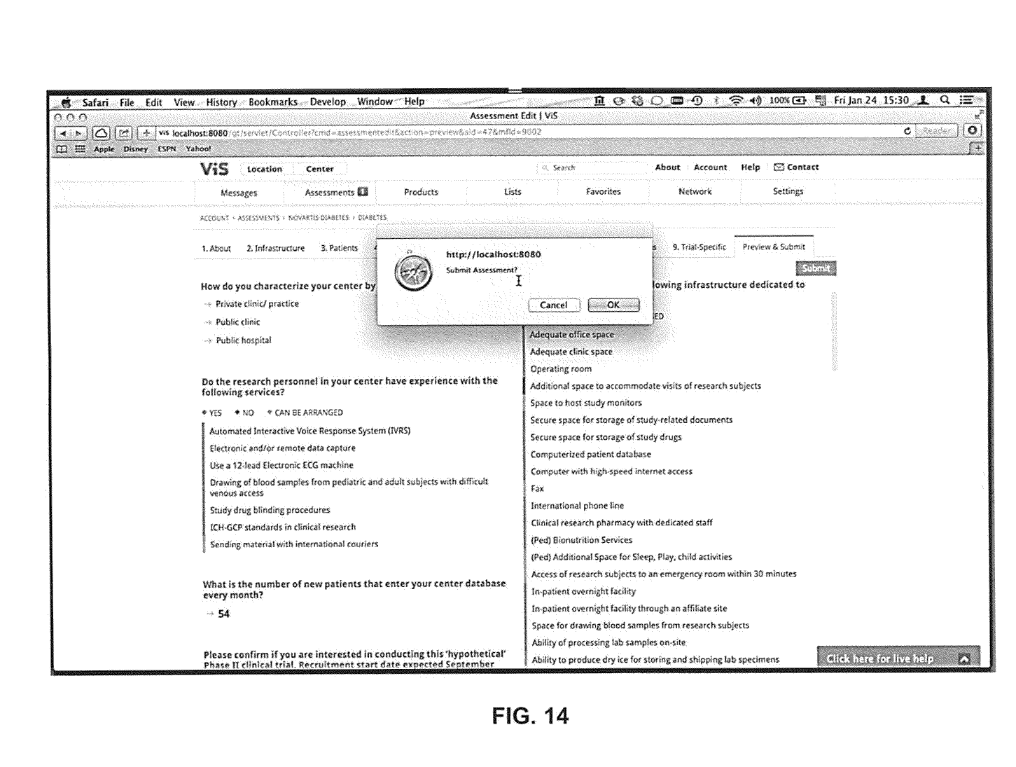

FIG. 14 shows a screen from which a completed assessment may be submitted, so that the trial planner can review it.

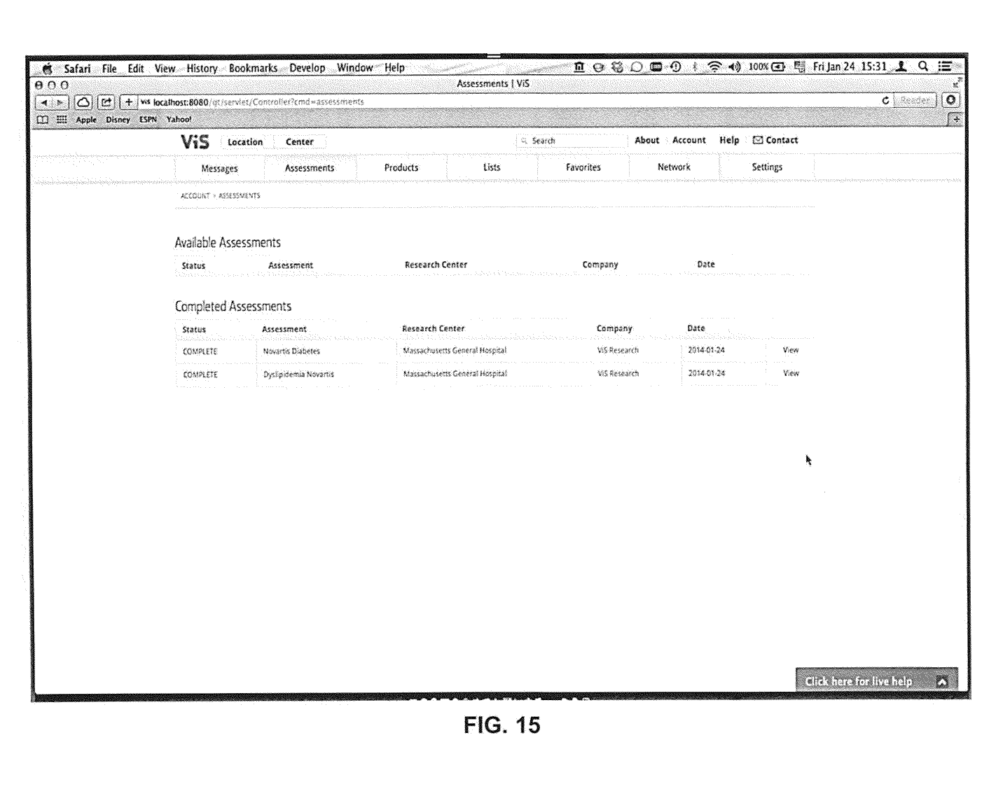

FIG. 15 shows that research center personnel have completed and submitted a final assessment. In some embodiments, once an assessment is submitted by the research center representative, that representative can no longer make any changes to their answers (but could view the completed assessment). Completing the assessment transfers the information back to the trial planner.

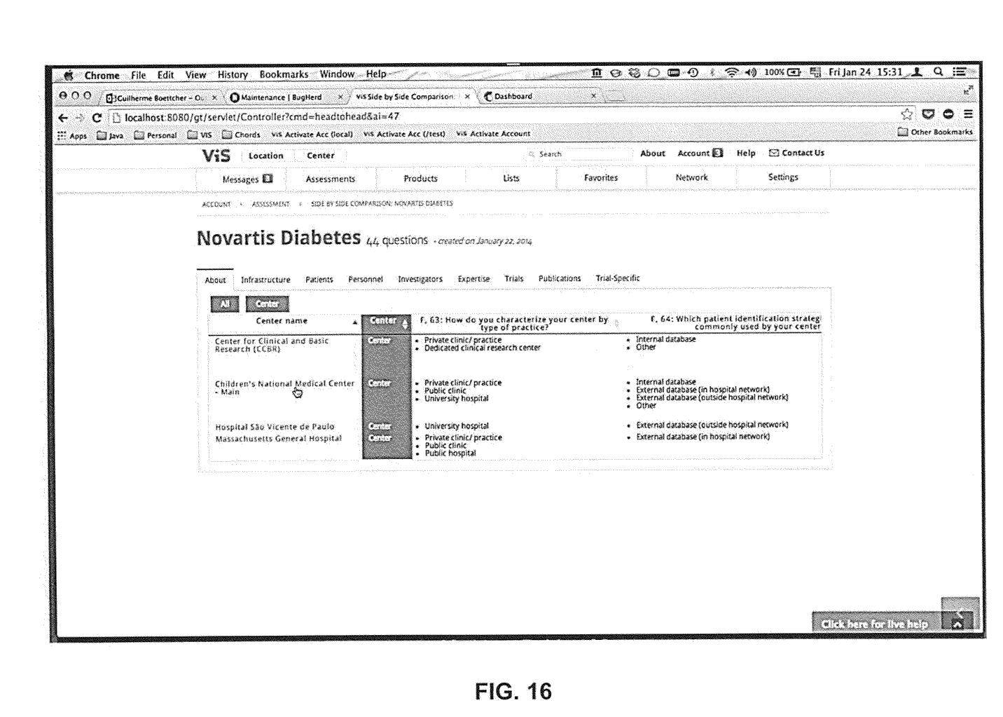

FIG. 16 gives a display 119 from the point of view of the trial planner. From this screen, the trial planner can use completed assessments to compare research centers. The left-most column is a list of centers that have completed assessments and the other columns show the responses by those centers to various questions.

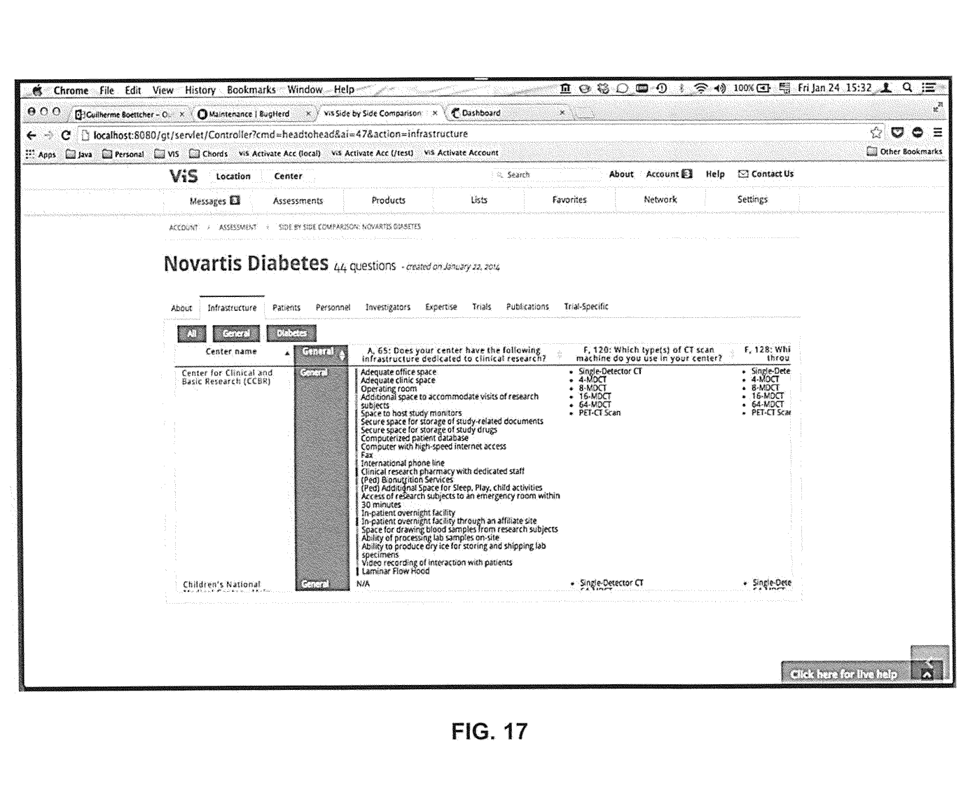

FIG. 17 shows an “infrastructure page” from which various research centers can be compared for the physical infrastructure that they possess. The list of answer results can be presented with a coding system, such as a color-coded bar to the left of each item, which indicates whether the research center has the infrastructure inquired about. Using the color-coded bars as an illustrative example, a green bar may mean that the research center has the infrastructure; a yellow bar may mean that the infrastructure is available nearby; and a red bar may mean that the infrastructure is not available.

It is noted in FIG. 17 that each tab (e.g., “Infrastructure”, “Personnel”, “Publications”, etc.) can show results that can be filtered by selecting either general or a disease-specific button. Toggling between these setting can show and hide the relevant answers for the queries.

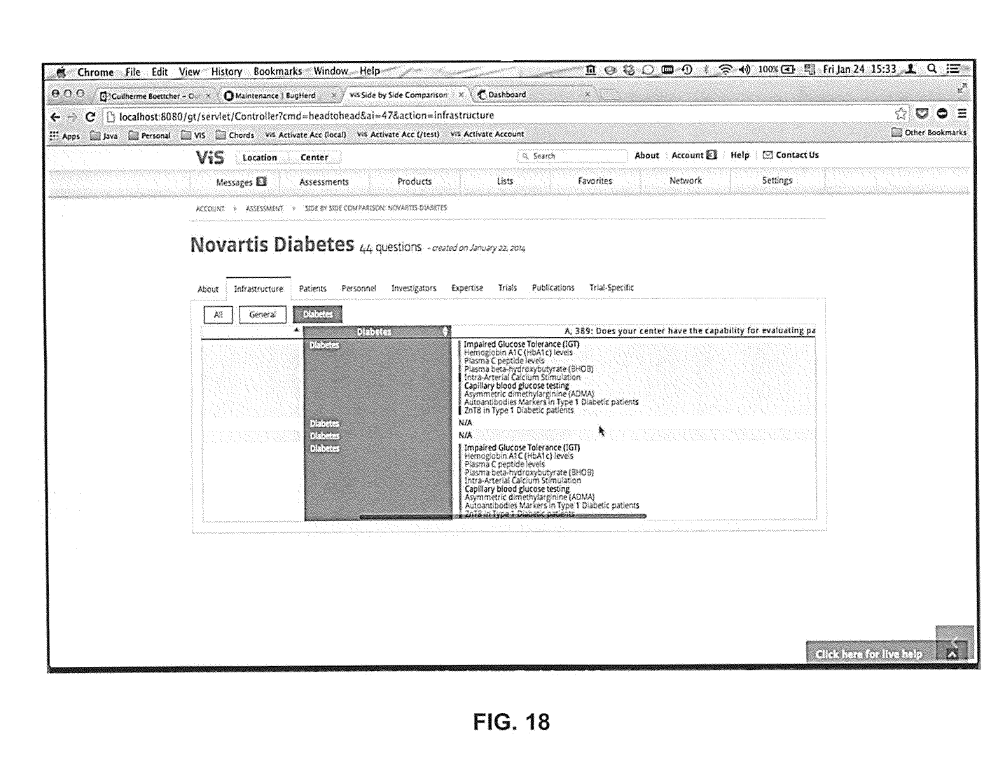

FIG. 18 shows a disease-specific infrastructure screen in which “Diabetes” has been selected (in comparison to FIG. 17, which gives a general view). It can be seen that a research center has responded to the assessment by providing that their center has capability for evaluating impaired glucose tolerance under the diabetes-specific questions in an assessment. Completed assessment can also give information about available patient populations.

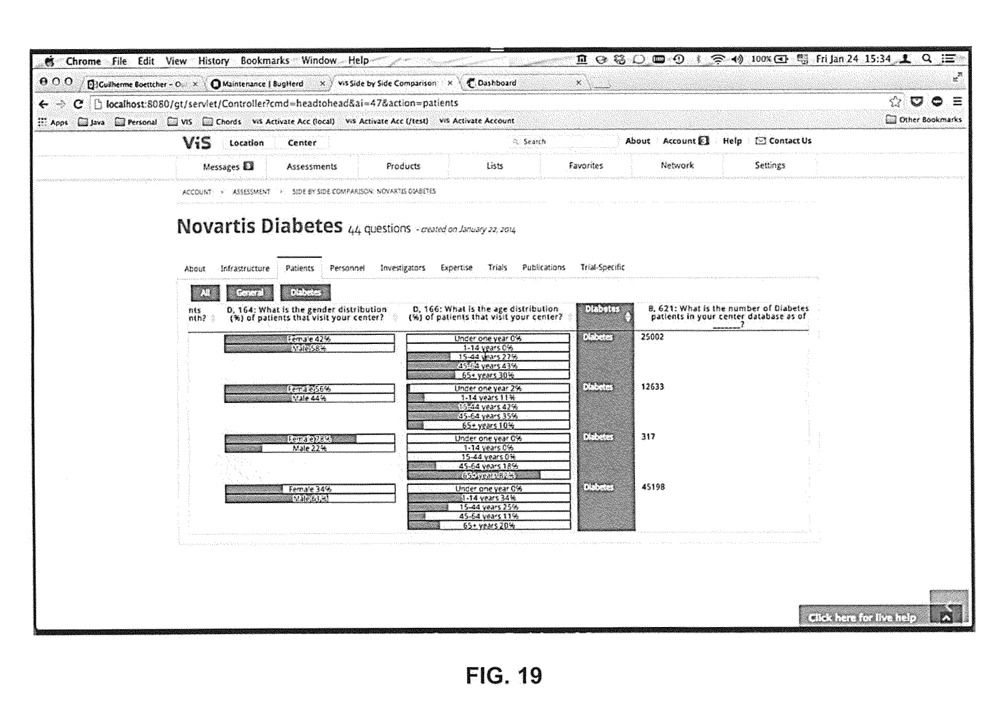

FIG. 19 shows how systems and methods of the invention may present information about patients that are available for trials. Here it can be seen that detailed demographic information is presented. It will be appreciated from the foregoing that systems and methods of the invention do much to improve the feasibility process. By integrating the assessment process (creation and completion) with the profiles in the system, a variety of information gains and time savings can be had.

For example, if a trial planner wants to include 95 questions, but many were answered in past, when center goes to answer, their work may be made much easier by previously-answered questions.

At another level, the disclosed functionality can be used to make comparisons among centers, even if one has not yet completed an assessment, as long as they have a profile. Moreover, in the event that two centers (A & B) are invited to complete an assessment, if center A has a profile but has not yet completed the assessment, while center B completes the assessment but does not already have a profile in the system, the trial planner can use systems and methods of the invention to compare center A to center B (i.e., even with in the on-screen direct comparison interface as shown, e.g., in FIGS. 16 & 17).

Another feature of the invention is the ability of the trial planner to weight questions and have the question weightings feedback into a set of reported scores for the centers. For example, while a trial planner is building an assessment, the planner can set up the expected answer options (e.g., yes, no, can be arranged) as well as designate a preferred or expected answer (e.g., “yes”). For that expected answer, the trial planner can set how important it is by setting a weight. For example, a weight scale could be made arbitrarily as 0-10 and the trial planner could select a value on the scale for each expected answer. Additionally or alternatively, the trial planner could establish that a certain answer is qualifying/ disqualifying. Once having set up the weights for the expected answers, the planner may push the questions to the centers. The results will then support the head-to-head comparisons as offered by systems of the inventions.

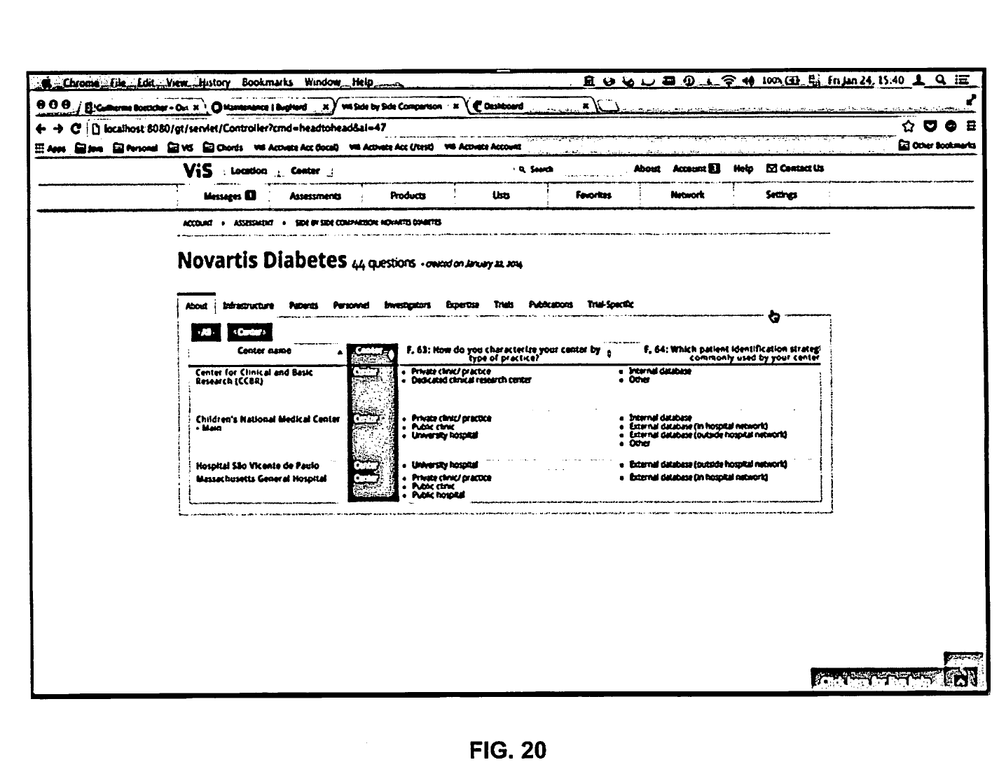

FIG. 20 illustrates a display for comparing centers. Here, centers such as Center for Clinical and Basic Research and Children's National Medical Center have answered questions pertaining to center characterization and patient identification strategies.

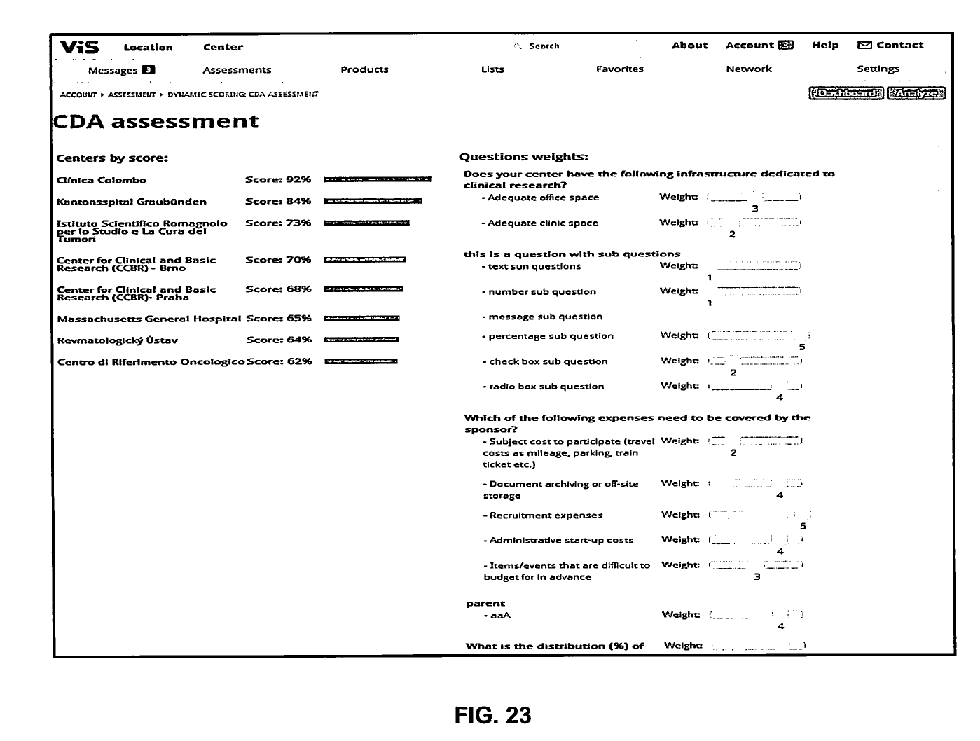

The trial planner has assigned weights to answer values. From the answers provided by the centers and the assigned weights, a score can be calculated for each centers. The display 119 can, in essence or exactly, report, “According to your criteria, from the 500 centers, the scores are . . . ” In some embodiments, systems of the invention allow a trial planner to adjust weights after-the-fact. In certain aspects, systems of the invention may display live, dynamic scoring of centers that reflects adjustments made to the weights. FIG. 23 illustrates a display for dynamic center scoring corresponding to question weight adjustments.

In certain embodiments, the invention provides systems and methods for generating scores for research centers. A score can be a display or report that gives values based on various variables, shows ranks on various axes, or represents qualities or capacities for a research center. In some embodiments, scores give assessment-specific scores based on weighted expected answer values, wherein the weights are specified by the trial planner.

A score gives a trial planner the ability to adjust relative weights that go into the creation of the score in an interactive manner. For example, a score can be obtained for one or more different research centers under consideration. In a preferred embodiment, a planner can assign or increase the strength of a consideration. The planner may, to illustrate, down-weight time for regulatory approval so that is only factors into about 5% of a location's score and up-weight patient population so that presently available patients factor into about 85% of the location's score. In some embodiments, the system provides scores that are composed and formatted for printing or inclusion in reports.

The planner can go back to the assessment and adjust the weights associated with each answer value, which things were qualifying/disqualifying, or both. This may change the scores that each center obtains. In this sense, the assigned score may not be a “global score”. That is, the trial planner may see a score for a research center showing how that center scores for that specific assessment under that trial planner's assigned weights. The system may optionally separately also support global scoring systems for research centers and, in fact, global scores can be included in the center inclusion criteria initially.

One important feature of the invention includes the integration of pre-loaded questions with open platform interaction to compose assessments. Open platform refers to the ability of centers to participate in the system prior to an assessment or to have a profile in the system that is accessible by the public or subscribers. The information from the center's participation with the system or profile in the system can provide answer information for questions. Questions can be pre-loaded both in the sense that actual question text may pre-exist in the system and in the sense that a trial planner can use a question in an assessment and have its answer value pre-loaded by the system prior to inviting the center(s) to complete the assessment.

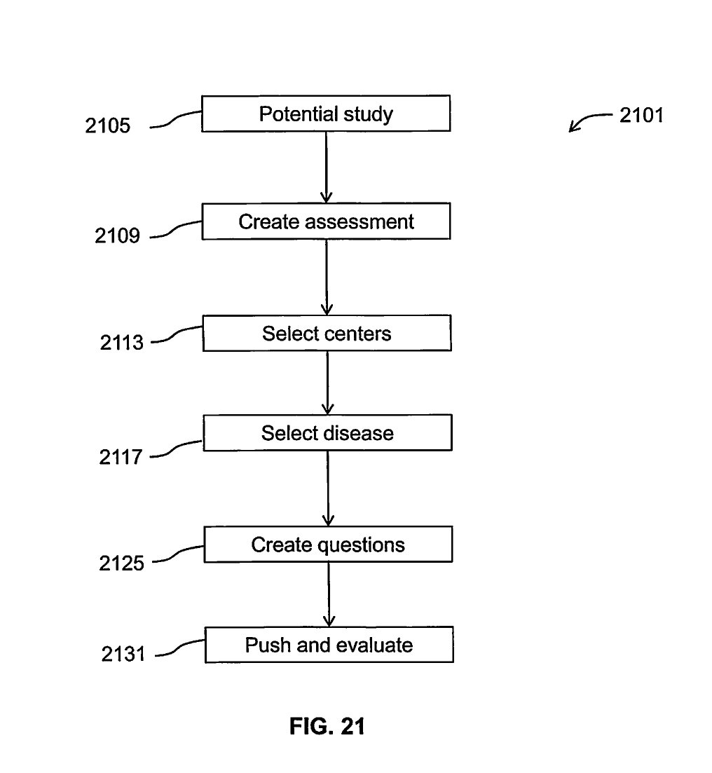

FIG. 21 diagrams methods 2201 according to certain embodiments. A trial planner will determine 2105 that a potential study is to be planned. The planner will create 2109 an assessment and select 2113 centers to be queried. These steps are not recited in a particular order and may be performed in other orders. The steps listed need not be all of the steps in assessment, nor need all the listed steps be performed. A trial planner may optionally select 2117 a disease, and will also generally create 2125 questions. The trial planner will push 2131 the assessments to the centers and evaluate the results once obtained.

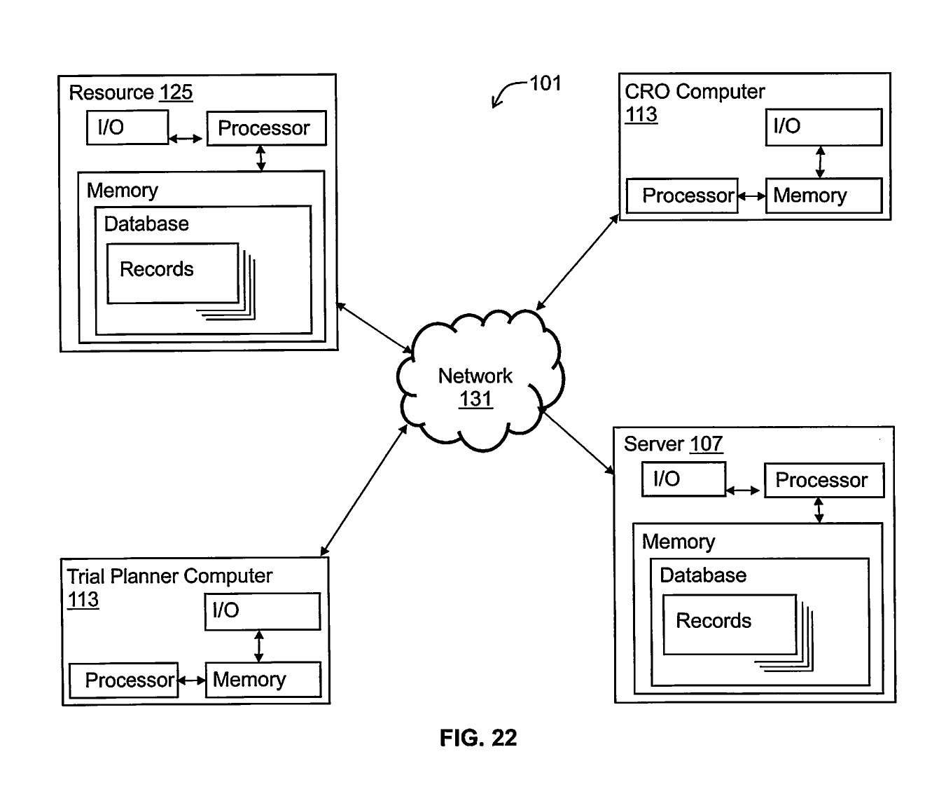

FIG. 22 shows a schematic of system 101 with some detail. System 101 may include, as-needed, server 107, planner computer 113, resource 125, a CRO computer 113, or a combination thereof.

Server 107 could include a rack-mounted computing device such as the server sold under the trademark BLADE by Hitachi (Santa Clara, Calif.).

A computer 113 could be a computer device such as the PC sold under the trademark SERIES 9 by Samsung (Seoul, South Korea), a notebook or desktop computer sold by Apple (Cupertino, Calif.) or a desktop, laptop, or similar PC-compatible computer such as a Dell Latitude E6520 PC laptop available from Dell Inc. (Round Rock, Tex.). Such a computer will typically include a suitable operating system such as, for example, Windows 7, Windows 8, Windows XP, all from Microsoft (Redmond, Wash.), OS X from Apple (Cupertino, Calif.), or Ubuntu Linux from Canonical Group Limited (London, UK).

Resource 125 may be a computer or system of linked computer provided for additional storage, data warehousing, or other functions. Resource 125 preferably includes at least one computer (e.g., a rack-mounted server) and may optionally include additional hardware dedicated to storage (e.g., a RAID array, tape driver, CD burner, etc.). Profiles for research centers, personnel, and geographic locations may be warehoused in resource 125 leaving server 107 to perform the steps of composing and administering assessments.

In generally, a computer will include a processor coupled to a non-transitory memory device and an input/output device.

A processor may be provided by one or more processors including, for example, one or more of a single core or multi-core processor (e.g., AMD Phenom II X2, Intel Core Duo, AMD Phenom II X4, Intel Core i5, Intel Core i7, Extreme Edition 980X, or Intel Xeon E7-2820).

Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

An input/output mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

In some embodiments, either of computer 113 or server 107 may be a tablet or smart-phone form factor device and s processor can be provided by, for example, an ARM-based system-on-a-chip (SoC) processor such as the 1.2 GHz dual-core Exynos SoC processor from Samsung Electronics, (Samsung Town, Seoul, South Korea).

The subject matter described herein can be implemented as one or more computer programs for execution by, or to control the operation of, system 101. A computer program may be deployed in any form, including as a stand-alone program or as a module, component, subroutine, or other unit suitable for use in a computing environment. A computer program (also known as a program, software, software application, app, macro, or code) can be written in any form of programming language, including compiled or interpreted languages (e.g., C, C++, Perl). Systems and methods of the invention can include instructions written in any suitable programming language known in the art, including, without limitation, C, C++, Perl, Java, ActiveX, HTML5, Python, Ruby on Rails, Visual Basic, or JavaScript. Programming in Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008). A computer program may be developed in a development environment such as Ruby on Rails or Groovy and Grails. See, e.g., Metz, Practical Object-Oriented Design in Ruby: An Agile Primer, Addison-Wesley (2012).

In some embodiments, systems of the invention include data regarding clinical research centers stored in a database, e.g., within server 107. A database application can be developed for use within server 107. Any development environment, database, or language known in the art may be used to implement embodiments of the invention. In some embodiments, an object-oriented development language, database structure, or development environment is used. Exemplary languages, systems, and development environments for development and operation of database 2013 include Perl, C++, Python, Ruby on Rails, JAVA, Groovy and Grails, Visual Basic .NET, Smalltalk, Objective C, and SQL (e.g., in the context of a Relational Database Management System such as MySQL, Oracle, Informix, or PostgreSQL). In some embodiments, implementations of the invention provide one or more object-oriented application and underlying databases for use with the applications. Databases are discussed in Date, C. J., Database design and relational theory, 2012, O'Reilly Media, Inc., Sebastopol, Calif., 260 pages, and Teorey, et al., Database Modeling and Design, 2011, Elsevier, Burlington, Mass., 304 pages.

In some embodiments, systems and methods of the invention can be developed using the Groovy programming language and the web development framework Grails or a similar product. Grails is an open source model-view-controller (MVC) web framework and development platform that provides domain classes that carry application data for display by the view. Grails domain classes can generate the underlying database schema. Grails provides a development platform for applications including web applications, as well as a database and an object relational mapping framework called Grails Object Relational Mapping (GORM). The GORM can map objects to relational databases and represent relationships between those objects. GORM relies on the Hibernate object-relational persistence framework to map complex domain classes to relational database tables. Grails further includes the Jetty web container and server and a web page layout framework (SiteMesh) to create web components. Groovy and Grails are discussed in Judd, et al., Beginning Groovy and Grails, Apress, Berkeley, Calif., 414 p. (2008) and in Brown, The Definitive Guide to Grails, Apress, Berkeley, Calif., 618 p. (2009). Exemplary systems and system architectures for use with the invention are described in U.S. Pub. 2011/0209133, U.S. Pub. 2011/0175923, and U.S. Pub. 2007/0112800, each of which is incorporated by reference herein in its entirety. Programming the hardware components of system 101 to perform functions described herein is part of the creation of specialized devices for clinical research assessment. Server 107 or computer 113 executes instruction stored in non-transitory memory and uses data stored in non-transitory memory, and those computers are not general-purpose computers as the non-transitory memory devices include extensive reconfigurations to include the profile data for the clinical research entities and the instructions for performing the clinical research assessments.

Other features and benefits provided by systems of the invention are described.

The invention provides systems and methods for composing, displaying, and using profiles. A profile can be a research center profile, a personnel profile, a location profile, or others. A location profile can include a display that provides information about a geographic location. Systems and methods of the invention provide location profiles that give information about clinical trial capacity associated with a location. In preferred embodiments, the location profiles can be disease-specific, and thus can show a capacity of a geographic location for performing a clinical trial specific to a certain disease. Some prior art directories addressed in-progress clinical trials at specific contract research organizations (CROs). Such directories tend to confound, not help, the problem, due to the fact that an in-progress clinical trial actually deducts from the present capacity of a geographical location to support a clinical trial (i.e., whatever number of patients are presently enrolled in a clinical trial are typically not then part of the clinical trial capacity associated with that location). Systems and methods of the invention recognize that a geographic location may be of primary interest to a planner (e.g., New England, the south of France, Latin America, São Paulo, Guangzhou, the greater Guangzhou metropolitan area, Canada, central Oregon, zip code 28804, the Willamette Valley, or an arbitrary area of the surface of Earth). In fact, once insight of the invention is that two geographical locations that are very different in scale may be of important similarity in terms of capacity for clinical trials. For example, a map view of the United States in a web browser that is “zoomed in” so that downtown Boston, Mass., fills most of the viewing area (such that everything visible in the map view is a geographical location) may have similar capacity for a clinical trial related to influenza as Slovakia—despite the significant difference in square mileage of those two locations.

In some embodiments, a trial planner may, from a location profile, view a presentation of main research entities and professionals operating in a given location. For example, U.S. Pub. 2013/0151276 (incorporated by reference) describes providing a profile of a research center. Such a center-specific profile (or similarly, an investigator-specific profile) may be linked to from within a location profile. An insight of the invention is that a profile of clinical trial capacity in a geographical location and a profile of a CRO are distinct things, serving separate purposes, and that the availability of the latter did not satisfy the demand for the former. (By analogy, knowing that some certain business in Roanoke has a printing press does not reveal whether one would be able to get 100,000 books printed in central Virginia within the next five days.). Thus, a location profile, as provided by the invention, depicts clinical trial capacity for a geographical location and may optionally also include information about specific research entities or personnel in that area (e.g., in the form of summary information or links to profiles specific to those entities or personnel). As discussed further herein, information may be provided in levels, wherein any public user can browse to and view certain qualities of information, but more detailed or specific information may be restricted to registered users or paid subscribers, for example.

Features of in the invention include providing a valuable commercial service that can be driven from a basic assessment creation and management page; providing disease-specific assessment tools; integrating information from numerous sources including, for example, an online mapping service, an online encyclopedia, a government registry of clinical trials, a national library of medicine publication database, or others; showing the integrated information as pre-loaded answers to assessment questions; integrating relevant regulatory guidance or benchmarking documents into the feasibility assessment process; providing contacts for relevant regulatory bodies or other service providers (such as couriers or translators) who may assist in assessing the viability of a trial in the area; and using feasibility assessment integrated with profile information to show research center capacity to conduct clinical trials on a drug that is proposed to treat a specific disease.

A trial planner can search for, find, or include research centers based on location if desired, where location may refer to countries or cities as well as states, and other levels of geographic location such as, for example: regions (e.g., “the south” in the United States or the Pacific Northwest); continents or subcontinents; geographically-identified regions (e.g., sub-Saharan Africa, the Loire valley in France, Latin America); zip code or postal code; named neighborhood (e.g., “The Castro”); economically or developmentally defined categories (e.g., emerging markets, BRIC countries (where BRIC is a grouping that refers to Brazil, Russia, India, and China); treaty signatories; the presence of historical co-collaborators; etc.). The geographical levels may be flexible. In some embodiments, a geographical level is defined by user input. For example, a trial planner views a map in a web browser and uses a mouse, touchscreen, or other device to zoom in to a particular level. The resulting map that is visible on screen defines the level of geographical location for a location profile, scorecard, or both.

In certain embodiments, the invention provides systems and methods for collecting information about clinical trial capacity of research centers, which information is stored in profiles and used to pre-populate assessment answers. Models of information-collecting put forth by the invention could be described as wiki-data or crowdsourcing. Some data may be obtained from online sources (e.g., an online mapping service such as Google Maps, an online encyclopedia, a government registry of clinical trials such as clinicaltrials.gov, a national library of medicine publication database such as PubMed, or others) while some data may be provided by users such as representatives of clinical research centers.

In certain embodiments, the invention provides for the integration of crowd-sourced input about centers into the profiles, the assessment process, or both. That is, a trial planner may use a system of the invention to collect or view information about patient availability for a study relating to a specific disease in certain research centers. The trial planner or other members of the community at-large may also provide information to the system from their own knowledge. An individual user may input their own qualitative knowledge of a specific center, researcher, etc., or may translate their qualitative knowledge into quantitative knowledge (e.g., by a multi-starred review system or a scoring system). Thus where a research centers appears through its profile in the system to have a very high patient availability for a certain condition (e.g., a high population affected with malaria), but one or a number of different trial planner experience that recruiting patients in that area is unduly challenging (perhaps for some unseen structural reason), those planners can input their evaluations, which the system can then fold into the profile, so that future assessment will be pre-populated with answers that reflect the input from the previous trial planners. In some embodiments, the system will override “hard data” obtained from an extrinsic source on the strength of crowd-sourced input. For example, if local directories indicate that two CROs are located within some certain national province, but numerous planner report that one has closed down, the system can respond by de-listing the reportedly closed CRO. As just discussed, crowd-sourcing may include receiving data from trial planners. Additionally or alternatively, information is received from professionals such as representatives of the research centers.

Systems and methods of the invention can be used to present data collection prompts, such as surveys or questions. One of skill in the art will recognize categories of information that may be pertinent to disease-specific clinical trials and questions may be presented to solicit that information. Information that may be solicited is disclosed in U.S. Pub. 2013/0151280; U.S. Pub. 2013/0151279; U.S. Pub. 2013/0151278; U.S. Pub. 2013/0151277; U.S. Pub. 2013/0151276; and U.S. Pub. 2013/0151275, the contents of each of which is incorporated by reference in their entirety. In certain embodiments, information is gathered from center representatives by having those representatives fill out center profiles or other forms displayable on a computer screen.

One insight of the invention is that changing profile levels could disrupt the information context within which a trial planner understands a location. The associated insight of the invention is that a trial planner derives value from information in the context of certain other information. Insights of the invention put to useful purpose by providing a benchmarking functionality that allows a trial planner to evaluate a center or a location based on variables that are benchmarked against information about other centers or locations available to the system.

One of skill in the art will recognize a variety of variables that can be benchmarked, including any information discussed in those co-owned U.S. patent applications listed above.

The benchmarked variable can be displayed graphically. For example, a bar can be shown that gives a percentile value for a variable. Use of a percentile gives a comparison of a location to all of the locations in the system. A planner can change disease and can change profile level (e.g., country to city) on the fly, and the system can update the benchmarks.

Use of benchmarks against other research centers (e.g., percentiles) gives important context to the information. For example, if a planner starts looking at all centers in Brazil and then dials down into Sao Paulo, the clinical trial capacity may appear large, but the planner may not have the immediate context for comparing that city to other cities in the globe. For example, if the planner sees that a city has 1,000 active Phase I clinical trials, but that the city is benchmarked at the 15th percentile, the planner then knows that there are other cities with many more Phase I clinical trials. Thus it is an insight of the invention that a percentile or a similar system for showing a rank of a location as compared to other locations or as compared to all of the locations is a functionality that well complements the ability to change between different scales of location profile. As a planner goes from country-level to city-level, it provides the important context to show how capacity in that city compares to capacities in all of the cities.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for performing a feasibility assessment for a clinical trial, the system comprising:
a server computer comprising a processor coupled to a memory and operable to:
store information about a research center in a profile;
receive a plurality of questions from a trial planner;
create an assessment comprising the plurality of questions;
pre-populate an answer for at least one of the questions using the information about the research center stored in the profile; and
provide the assessment to a representative of the research center.

2. The system of claim 1, wherein the representative of the research center sees the pre-populated answer.

3. The system of claim 1, further operable to save a plurality of assessments and transmit the saved assessment to research centers upon instruction by a trial planner.

4. The system of claim 1, further operable to receive a revised assessment from a research center and to provide the revised assessment to the trial planner.

5. The system of claim 4, further operable to update the profile to include new information obtained from the representative answering the assessment.

6. The system of claim 1, further operable to receive, from the trial planner, expected answers for the plurality of questions.

7. The system of claim 6, further operable to allow the trial planner to assign a weight to each of the expected answers.

8. The system of claim 6, further operable to receive answer values for the plurality of questions from the research center;
calculate a score for the research center based on the weights for the expected values and the received answer values; and
provide the trial planner with the score for the research center.

9. The system of claim 8, further operable to show the trial planner a dynamic comparison between the research center and a second research center based on the score for the research center and a second score for a second research center, wherein the score and the second score are adjusted and provided to the trial planner, in real-time, based on changes to the weights for the expected value and the received values.

10. The system of claim 1, further operable to show the trial planner a comparison between the research center and a second research center based on answers that include information from the profile and information provided by research center personnel.

11. A computer-implemented method for preforming a feasibility assessment for a clinical trial, the method comprising:
using a server computer comprising a processor coupled to a memory to:
store information about a research center in a profile;
receive a plurality of questions from a trial planner;
create an assessment comprising the plurality of questions;
pre-populate an answer for at least one of the questions using the information about the research center stored in the profile; and
provide the assessment to a representative of the research center.

12. The method of claim 11, wherein the representative of the research center sees the pre-populated answer.

13. The method of claim 11, further comprising saving a plurality of assessments and transmitting the saved assessment to research centers upon instruction by a trial planner.

14. The method of claim 11, further comprising receiving a revised assessment from a research center and presenting the revised assessment to the trial planner.

15. The method of claim 14, further comprising updating the profile to include new information obtained from the representative answering the assessment.

16. The method of claim 11, further comprising receiving, from the trial planner, expected answers for the plurality of questions.

17. The method of claim 16, further comprising allowing the trial planner to assign a weight to each of the expected answers.

18. The method of claim 16, further comprising receiving answer values for the plurality of questions from the research center;
calculating a score for the research centers based on the weights for the expected values and the received answer values; and
providing the trial planner with the score for the research center.

19. The system of claim 16, further operable to show the trial planner a dynamic comparison between the research center and a second research center based on the score for the research center and a second score for a second research center, wherein the score and the second score are adjusted and provided to the trial planner, in real-time, based on changes to the weights for the expected value and the received values.

20. The method of claim 11, further comprising showing the trial planner a comparison between the research center and a second research center based on answers that include information from the profile and information provided by research center personnel.
